(19) United States
(12) Patent Application Publication
(10) Pub. No.: US 2003/0115395 A1
(43) Pub. Date: Jun. 19, 2003

(54) Universal communication device and peripheral docking station

(76) Inventors: Yves Karcher, Cully (CH); Denis Pavillard, Renens (CH); Sergio Lazzarrato, Marin (CH); Rolf Ambuehl, Lausanne (CH); David Maltz, San Francisco, CA (US); Chris Bull, Danville, CA (US); Stephane Delorenzi, Lausanne (CH)

Correspondence Address: FENWICK & WEST LLP, SILICON VALLEY CENTER, 801 CALIFORNIA STREET, MOUNTAIN VIEW, CA, 94041, US

(21) Appl. No.: 10/231,672

(22) Filed: Aug. 29, 2002

Related U.S. Application Data
(60) Provisional application No. 60/316,348, filed on Aug. 30, 2001.

(51) Int. Cl. G06F 13/14

(52) U.S. Cl. 710/303

(57) ABSTRACT

A peripheral device station couples two or more peripheral devices with a host computer system. The station includes two or more peripheral device interfaces, a power unit, a communication intermediary, and a host interface. At least one peripheral device interface includes a communication connection and a power connection. The power unit couples with the power connection and provides an electrical charge for charging a power source of a peripheral device. The communication intermediary couples with the communication connection and provides a communication coupling between a peripheral device and the host computer system. The host interface couples with and communicates with the host computer system.

### RELATED APPLICATION

This application claims priority to U.S. provisional patent application No. 60/316,348, filed Aug. 30, 2001, the contents of which are hereby incorporated by reference.

### BACKGROUND OF THE INVENTION

1. Field of Invention

The present invention relates to a universal communication device and input device docking station.

2. Description of the Related Arts

A conventional base station for use with a conventional input device is known. The base station is a relatively large form factor device that may also be relatively heavy in weight. The conventional base station often serves as a docking station for synchronizing the conventional input device with a computer via a wire connection only when the input device is physically connected with the base station. In addition, some conventional base stations also allow for charging the conventional rechargeable input device when the two are physically connected.

A conventional recharge or base station for a conventional rechargeable input device has a number of drawbacks. Typically, the conventional recharge station lacks functionality beyond basic recharging or tethered data synchronization. For example, the conventional recharge station lacks functionality such as wireless communication capability, and therefore, limits their use in terms of range and portability. Although the conventional recharge station does provide a good balance between a bulky battery and a replaceable battery, it has the disadvantage of being relatively bulky itself as well as being unique to each individual input device type. This limits its practical use as a useful item for mobile individuals that have two or more wireless devices and require the individual recharge stations for each device. This increase in the number of individual recharge stations consumes limited desk or workspace while increasing work clutter.

Therefore, there is a need for a universal communication input device docking station for use with one or more input devices with power source replenishment capability within a substantially unitary offering, while providing added functionality such as a communication intermediary.

### SUMMARY OF THE INVENTION

The present invention includes a peripheral device station (or universal station) that couples two or more peripheral devices with a host computer system and also provides docking features such as stowage, communications medium, and power replenishment. The peripheral device station includes two or more peripheral device interfaces, a power unit, communication intermediary, and a host interface.

At least one of the two or more peripheral device interfaces is configured to couple with at least one peripheral device. In addition, at least one peripheral device interface comprises a communication connection and a power connection. The power unit couples with the power connection and is also configured to provide an electrical charge for charging a power source of a peripheral device. The communication intermediary couples with the communication connection and is also configured to provide a communication coupling between a peripheral device and the host computer system. The host interface is configured to couple with and communicate with the host computer system.

An advantage of the present invention is that it provides a unitary, or centralized, location for stowage of two or more peripheral devices. Moreover, the present invention beneficially provides a communication interface and a power interface for the two or more peripheral devices. This allows a unitary device to provide communication capabilities and power replenishment (e.g., recharge) services with a host computer system through one station. Furthermore, the present invention may be configured to provide a universal peripheral device interface to allow complementary interfaced peripheral devices to couple with the universal station without a need for individually unique interfaces for each specific peripheral device.

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

### BRIEF DESCRIPTION OF THE FIGURES

Figure (“FIG. ”) 1 generally illustrates a peripheral device station (“universal station”) that is configured to provide communication and docking functionality for two or more computer peripheral input devices in accordance with one embodiment of the present invention.

FIG. 2 is a block diagram of a computing architecture for a universal communication and docking system, including electrical (e.g., power and data) and mechanical architectural components and interface connections, in accordance with one embodiment of the present invention.

FIG. 3 is a block diagram of components of a universal station architecture in accordance with one embodiment of the present invention.

FIG. 4 is a block diagram of components of a wireless communication circuit for a universal station in accordance with one embodiment of the present invention.

FIG. 5 is a diagram of a handheld character capture device in accordance with one embodiment of the present invention.

### PREFERRED EMBODIMENTS OF THE PRESENT INVENTION

Figure (“FIG. ”) 1 generally illustrates a peripheral device station (“universal station”) 101 that is configured to provide communication and docking functionality for two or more computer peripheral input devices in accordance with one embodiment of the present invention. The universal station 101 includes a base 103, one or more connection points 105, one or more optional device connect switches 110, a display screen 115, a power connection 117, and a host connection 130. The universal station 101 connects with a host computer system 125 through the host connection 130.

One or more computer peripheral devices connect with the universal station 101 through the one or more connection points 105. The connection points 105 provide a universal connection mechanism between the universal station 101 and a peripheral device. Examples of the one or more peripheral devices (generally 120) include a cordless (or wireless) pointing device (e.g., a mouse, a trackball, or joystick) 120a, a cordless keyboard 120b, a cordless camera 120c, a cordless headset 120d, and a cordless data capture device 120e. The universal station 101 also includes an optional device connect switch 110, an optional indicator and/or display (e.g., a liquid crystal display (“LCD”) or plasma-type display) 115, and a power line 117 for plugging into a power supply.

The optional connect switch 110 may include a simple electrical, electromechanical, opto-electrical, or photosensitive switching unit to wirelessly couple the universal station 101 with the cordless devices 120. The connect switch 110 is configured to function as a mechanism to create “virtual wire” between the universal station 101 and a particular peripheral device 120. The optional connect switch 110 may include a keypad (e.g., a 12 key number pad) that may be used to identify the specific peripheral device 120 for connection. For example, pressing “1” and “connect” on the keypad creates a wireless connection between the universal station 101 and the cordless mouse 120a. Information on which peripheral devices 120 connect via the “virtual wire(s)” may appear on the optional indicator and/or display 115. The optional indicator and/or display 115 may also be used to provide other types of information, for example, warning beeps, status lights or messages, and the like.

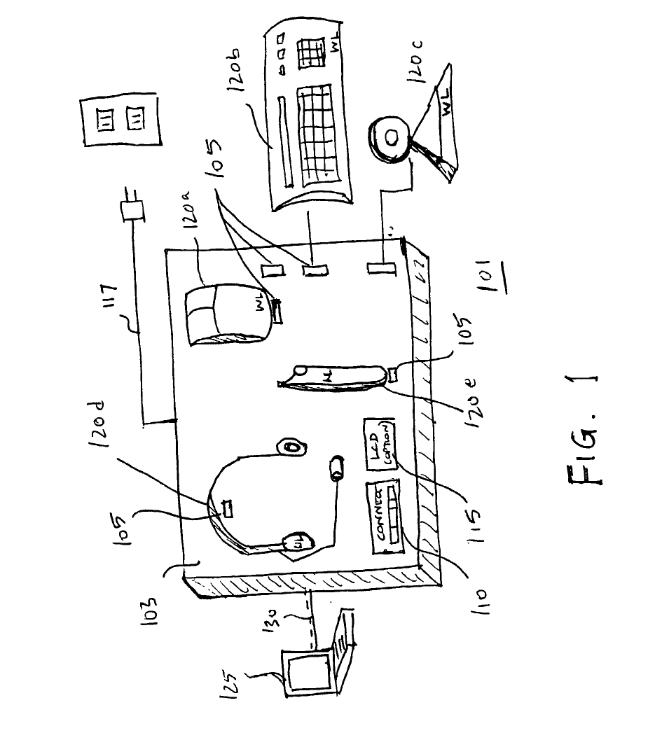

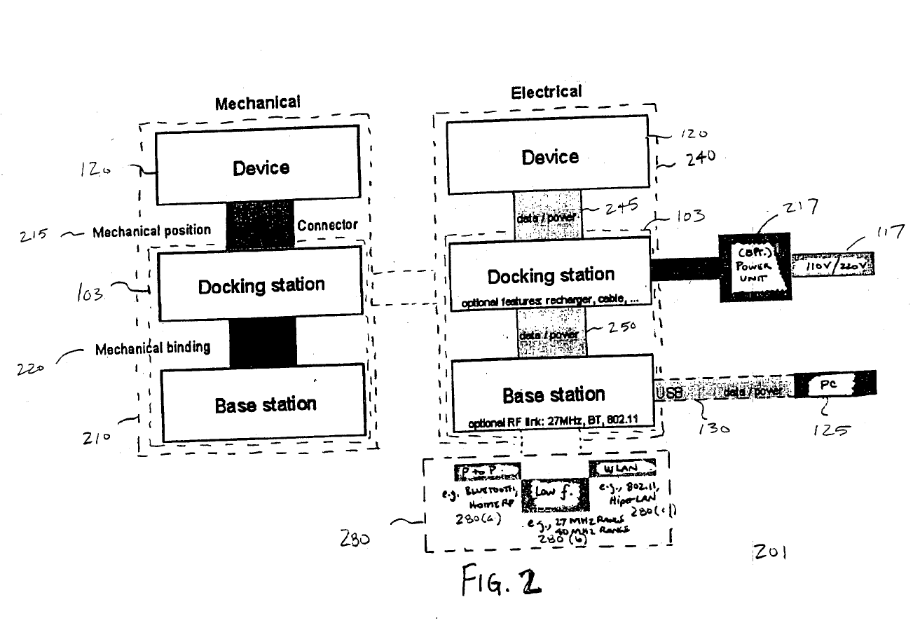

FIG. 2 is a block diagram of a computing architecture 201 for the universal station 101, including a mechanical and an electrical (e.g., power and data) architectural interface 210, 240, in accordance with one embodiment of the present invention. The mechanical interface 210 includes a mechanical position connector 215 and a mechanical binding 220. The mechanical position connector 215 is for mechanically coupling the peripheral device 120 with the base 103 of the universal station 101. The mechanical binding 220 couples a docking station portion with a base station portion of the base 103 of the universal station 101. From a mechanical perspective, the docking station provides a location for the actual connection with the peripheral device 120 and the base station provides storage for that peripheral device 120.

It is noted that the mechanical interface 210 may be fixed with the docking station. Alternatively, the mechanical interface 210 may include a tether that can extend from the docking station. The tether can be retractable or pre-set in either the fixed or tethered configuration. The mechanical interface allows for physically coupling the docking station with a peripheral data communication device. The mechanical interface 210 may be a custom configuration in which particular pin sets are used to provide particular functionality that may be unique with regard to the peripheral device 120 connecting with the universal station 101. Alternatively, the mechanical interface 210 may be a USB or a serial communication interface pin set. In yet another embodiment, the mechanical interface may be an RJ-45 type network connection.

The electrical interface 240 allows for data transmission and may allow for power transmission. The electrical interface 240 includes two data and power connections, 245, 250. One data and power connection 245 is for electrically coupling the peripheral device 120 with the base 103. The other data and power connection 245 is for electrically coupling power features that may be associated with the docking station with the communication features that may be associated with the base station features. The docking station also couples with a power source through the electrical outlet connection 117. An optional power unit 217 may be present to serve as a transformer. The docking station also provides a connection for recharging batteries or other power sources in the peripheral device 120.

Electrically, the base station couples with the host computer 125 through a computer connection 130, for example, a USB port, a parallel port, an RS/232 serial port, a PS/2 port, or an IEEE 1394 port. The base station also provides a communication coupling functionality to communicate through a communication link 280. The communication link 280 may be an infrared link, a peer-to-peer link, e.g., Bluetooth or HomeRF, a low frequency link, e.g., 27 MHz or 40 MHz, a higher frequency link, e.g., 233 MHz or 900 MHz, or a wireless local area network link, e.g., IEEE 802.11 (b, g, or a standard) or HiperLAN (or /2 standard). The electrical interface 240 may be tethered (e.g., wired) or non-tethered (e.g., wireless). In addition to communication links, it is noted that the electrical interface 240 may also provide a power connection for powering a peripheral device 120 through the docking station. The power connection may be used to provide real-time power or charging power to charge a power source in a cordless peripheral device 120.

The present invention also uses an appropriate communication protocol for communication between the universal station 101 and the host computer system 125. For example, a USB protocol is used if the connection is through a USB port, an IEEE 1394 protocol is used if the connection is through an IEEE 1394 port, or a Bluetooth protocol is used if the connection is through a Bluetooth 2.4 GHz range radio frequency link. Generally, it is noted that the mechanical and electrical functionality of the docking station and the base station may be combined into one and that the mechanical and electrical couplings may also be functionally combined.

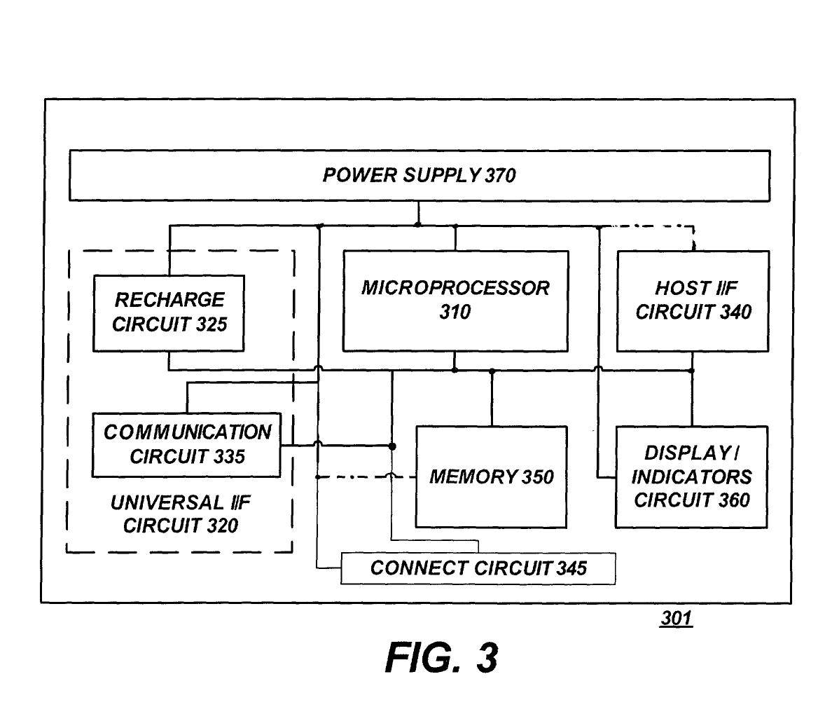

FIG. 3 is a block diagram of components 301 of a universal station 101 architecture in accordance with one embodiment of the present invention. The components 301 of a universal station 101 include a microprocessor (or microcontroller) 310, a universal interface circuit 320, a host interface circuit 340, a connect circuit 345, a memory 350, a display and/or indicator circuit 360, and a power supply 370. The universal interface 320 includes a recharge circuit 325 and a communication circuit 335.

The microprocessor 310 couples with the recharge circuit 325 and the communication circuit 335 of the universal interface 320. The microprocessor 310 also couples with the host interface 340, the connect circuit 345, the memory 350, the display and/or indicator circuit 360, and optionally the power supply 370. The power supply 370 also couples the recharge circuit 325 and the communication circuit 335 of the universal interface 320, the connect circuit 345, and the display and/or indicator circuit 360. The power supply also optionally couples with the host interface 340 and the memory 350.

The microprocessor 310 is a conventional microprocessor or microcontroller, for example, an Intel or Motorola microprocessor or microcontroller. Alternatively, the system may be configured with a custom application specific integrated circuit (“ASIC”) independent of, or in addition to, the microprocessor 310. The microprocessor 310 may also include one or more volatile or non-volatile memories and/or memory caches for storing data, instructions, commands, and/or other information. In one embodiment the microprocessor 310 may process the data communicated with the peripheral device 120, either alone or in conjunction with the host computer system 125. The processing may be configured for real-time data transfer or alternatively could be configured for batch-type processing.

As previously described, the universal interface 320 includes the recharge circuit 325 and the communication circuit 335. The universal interface circuit 320 provides a wireless connection or a pin connection for coupling with one or more peripheral devices 120. The universal interface circuit 320 may be configured to include operability with universal station 101 described with respect to FIG. 1 and the mechanical interface 210 and the electrical interface 240 described with respect to FIG. 2. For example, the universal interface circuit 320 includes an embodiment of the docking station and base station of the base 103 of the universal station 101.

In the universal interface circuit 320, the recharge circuit 325 provides a supply of power and power transfer regulation circuit for replenishing or recharging a power source in the peripheral device 120. The communication circuit 335 provides a cordless (wireless) or corded (wired) communication link 280 between the peripheral device 120 and the universal station 101. Examples of a wireless communication link include the peer-to-peer link, the low-frequency link, or the wireless local area network link previously described. Examples of a wired communication link include the USB or IEEE 1394 link previously described.

The host interface circuit 340 includes the pin connections for the host connection 130 to the host computer system 125. The host interface circuit 340 may be a conventional wired host interface, e.g., a USB interface or a parallel port interface, or it may be a custom interface. The host interface circuit 340 may also be a wireless interface, e.g., Bluetooth, when the host connection 130 is a wireless connection to the host computer system 125.

The connect circuit 345 includes the circuitry for the optional connect switch 110 described previously. The connect circuit 345 may include a keypad matrix to identify a peripheral device interface (or port) and a peripheral device 120 attached to it so that the universal station 101 can establish a virtual wire. The connect circuit 345 may also provide initialization parameters for establishing though the universal interface 320 the virtual wire between the peripheral device 120 and the universal station 101.

The memory 350 is a conventional volatile and/or non-volatile memory. The memory 350 may include a static random access memory, a dynamic random access memory, a flash memory, an electrically erasable programmable read only memory, a disk, or the like. The memory 350 may provide short-term (e.g., cache or buffer) and/or long-term storage (e.g., saved files). The display/indicator circuit 360 is conventional circuitry that powers and operates a display and/or indicator functions (e.g., sound, lights, messages) similar to the display and/or indicator 115 previously described. The power supply 370 is a conventional power supply used to power the components 301 of the universal station 101. The power supply 370 couples with the power line 117 described previously. In addition, the power supply 370 may include the optional power transformer 217 described previously.

Generally, a cordless type peripheral device 120(1) that functions with the universal station 101, may be stowed on (or at least partially within) the universal station 101 such that an interface connection on the peripheral device 120 couples with recharge circuit 325. Further, if data must be transferred between the host computer system 125 and the peripheral device 120, the interface connection on the peripheral device 120 also couples the communication circuit 335. The communication circuit 335 communicates with the host computer system 125 through the microprocessor 310 and the host interface circuit 340 of the universal station 101.

In one embodiment, another cordless-type peripheral device 120(2) (e.g., a cordless mouse) may be in use by a user and de-coupled from the universal station 101. To ensure that the universal station 101 recognizes the peripheral device 120(2), a user may trigger the connect switch to match the device with the station (e.g., through a keypad and connect switch as previously described). The peripheral device 120(2) may be configured to communicate with the host computer system 125 through a wireless communication link (e.g., low frequency (27 MHz) link or Bluetooth link) with the communication circuit 335, the microprocessor 310, and the host interface circuit 340 of the universal station 101.

In another embodiment, a tethered peripheral device 120(3) (e.g., a video camera) may also be in use and operational with the universal station 101. In this embodiment, the tethered peripheral device 120(3) may be configured to temporarily store data in the memory 350 of the universal station. The tethered peripheral device 120(3) couples the communication circuit 335 through a mechanical (or wired) connection (e.g., USB connection or an IEEE 1394 connection) and the microprocessor 310 directs the data received by the universal station 101 to the memory 350.

The components 301 of the universal station 101 provide a system that allows for stowage, communication and/or power replenishment for two or more peripheral devices 120 that connect to the universal station. The peripheral devices 120 do not require individual, often customized (for that device) docking stations for coupling with a host computer. Moreover, the universal station 101 provides added functionality of a communication intermediary that provides a communication link between the peripheral devices 120 and the universal station 101 and/or the host computer system 125. Furthermore, it is noted that the principles of the present inventions may be applicable to devices other than a peripheral device, for example, personal digital assistants, which helps reduce the number of conventional recharge and docking units to increase desk space or workspace and further eliminates clutter for computing users.

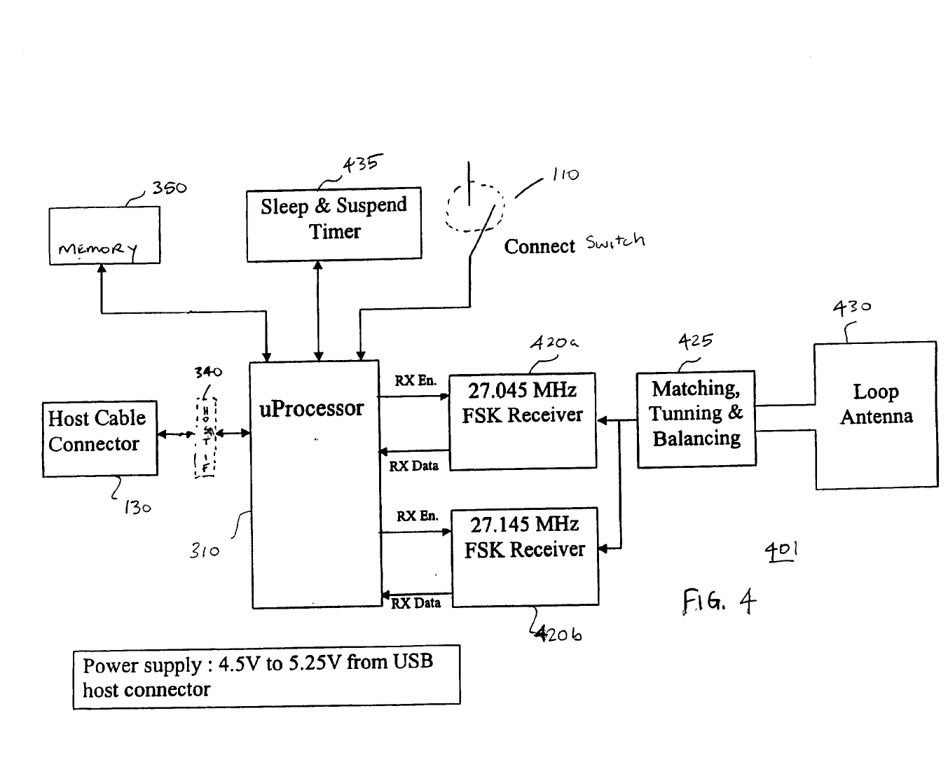

FIG. 4 is a block diagram of components of an exemplary wireless communication system 401 for a universal station 101 in accordance with one embodiment of the present invention. It is noted that although a low-frequency design is illustrated, the principles disclosed herein apply to high frequency non-tethered devices (e.g., peer-to-peer or WLAN enabled peripheral devices) and to tethered communication devices.

The wireless communication system 401 include the microprocessor 310, the memory 350, a radio frequency receiver 420, a radio-tuning unit 425, an antenna 430, a timer 435, the host interface 340, the host connector 130, and the connect switch 110. The microprocessor 310 couples with the non-volatile memory 350, the radio frequency receiver 420, the timer 435, the host cable connector 130, and the connect switch 110. The radio frequency receiver 420 couples with the tuning unit 425. The tuning unit 425 couples with the antenna 430.

The radio frequency receiver 420 is a conventional radio frequency receiver, for example, a 27 MHz range (e.g., 27.045 MHz to 27.145 MHz) low-frequency shift keying (“FSK”) receiver or a 2.4 GHz range receiver (e.g., a peer-to-peer receiver such as Bluetooth or HomeRF). Example embodiments of a radio frequency receiver 420 and complementary cordless peripheral device are disclosed in U.S. patent application Ser. No. 09/654,194 entitled “Wireless Peripheral Interface with Universal Serial Bus Port” and U.S. patent application Ser. No. 09/653,118 entitled “Multilink Receiver for Multiple Cordless Applications,” both of which are assigned to Logitech, Inc. The relevant portions of these applications are herein incorporated by reference.

The antenna 430 is a conventional antenna optimized for use with a particular frequency range, for example, a loop antenna for use with low frequency systems or a whip or dipole antenna for other frequency ranges. In addition, the radio-tuning unit 425 provides radio-frequency signal matching, tuning, and balancing functionality.

Operation of the wireless communication system 401 as illustrated in FIG. 4 can be described in an example of a data receiving operation with one of the cordless peripheral devices 120 (e.g., a cordless handheld optical character capture device or a cordless mouse) operating in a 27 MHz frequency range. When the cordless peripheral device transmits data through its antenna system, the antenna 430 picks up the radio frequency signal and the tuning unit 425 forwards this signal to the radio frequency receiver. If the microprocessor 310 is in a sleep cycle, the timer unit 435 turns on the microprocessor 310. The microprocessor 310 processes the radio frequency signal and stores the data from the radio frequency signal in the memory 350 and/or forwards the data to the host computer system 125 through the host interface 340 and host connector 130. It is noted that the wireless communication system 401 of the universal station 101 may be powered by a separate power supply or through the USB connection with the host computer system 125.

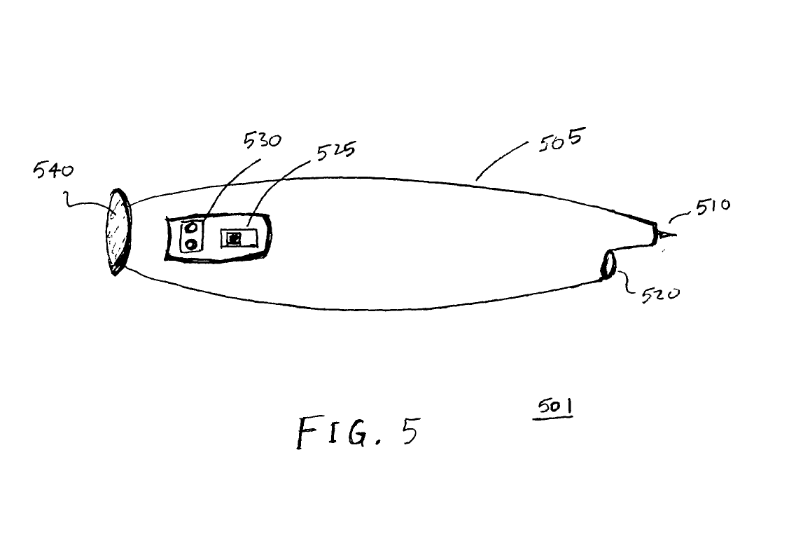

FIG. 5 is a diagram of an exemplary peripheral device 120, e.g., a handheld character capture device 501, in accordance with the present invention. In one embodiment, the handheld character capture device 501 is an optical type device that may be configured similar to the digital pen peripheral device 120e described above with regard to the universal station 101 described above. The handheld capture device 501 may be configured in any shape that would be comfortable with a user. For example, the device 501 may be configured structurally similar to a conventional writing instrument (e.g., a pen). The handheld capture device 501 includes a housing 505, an outline (or pen) tip 510, a data capture unit 520, an optional tip switch 525, an optional electrical switch 530, and a universal interface connector (or a peripheral device connector) 540.

The housing 505 may be shaped as an elongated barrel of, for example, 10 to 15 centimeters in length and having diameter or width of, for example, 1 to 3 centimeters. The interior of the data capture pen device provides a housing for electronics and may include an ink-writing instrument. The device 501 may be configured as an encoding apparatus that captures handwritten information, e.g., text or drawings, from a writing medium, e.g., paper, into digital form, e.g., data.

The outline tip 510 may be in close proximity to the data capture unit 520 so that the data capture unit 520 can capture images of characters outlined by the outline tip 510. The outline tip 510 may also include an ink-writing tip for handwriting and drawing functions. Alternatively, the device 501 can work without the ink-writing tip, for example, as a stylus that creates a pattern that can be imaged off of a digital or non-digital surface. In another embodiment, the outline tip 510 includes a contact sensor (e.g., using a switch or force/pressure sensor) and detects pressure on the writing medium or detects contact with the writing medium for capturing the handwritten information. In such an embodiment, the data capture unit 520 detects the movement of the tip relative to a surface and maps that movement to a character stroke.

The optional tip switch 525 may be configured to retract or extend the outline tip 510 into or out of the housing 505. Alternatively, the device 501 may include a cap to cover and protect the pen tip. The optional electrical switch 530 may be configured to turn on or off the electrically powered components of the device 501.

The universal interface connector 540 may be a wireless connector or a mechanical connector that is a reciprocal to a peripheral device interface coupled with the universal interface circuit 320 on the universal station 101. Further, the universal interface connector 540 includes an electrical interface that allows for the wireless or mechanical connector to provide a serial synchronous or asynchronous bi-directional interface communication link. Examples of such bi-directional interfaces include conventional tethered interfaces (e.g., IEEE 1394, SPI, and USB) or non-tethered interfaces (e.g., Bluetooth, HomeRF).

The communication link of the electrical interface allows for data transfer between the device 501 and the universal station 101. When the device 501 is operational and capturing data, the transfer of data may be in a real-time transfer mode if the universal interface connector 540 couples with the universal interface circuit 320 of the universal station 101. This real time data can be stored on a magnetic storage medium and/or displayed on a monitor or other display.

Alternatively, the data transfer may be in a download mode in which data is captured, stored, and later transferred once the universal interface connector 540 of the handheld character capture device 501 couples with the universal interface circuit 320 on the universal station 101. In either real-time or download mode, the system may be configured to synchronize data and other information between the device 501 and the host computer system 125. The system of the present invention may be configured to download data, transfer data real-time, or synchronize data either automatically upon coupling of the mechanical connectors or upon using a connection establishment or synchronization button or software routine in either or both devices.

In addition to the communication link, the electrical interface of the universal peripheral connector 540 includes a power connection. The power connection portion of the electrical interface in the universal interface connector 540 is configured to couple with the recharge circuit 325 in the universal station 101. The recharge circuit 325 controls power source (e.g., rechargeable battery) recharging in the handheld data capture device 501.

Turning briefly to the wireless connector of the universal interface connector 540, it may be configured for wireless communication through a reciprocal connection to the communication link 280 previously described. Similarly, the mechanical connector may also be configured through a communication link that reciprocates with a mechanical position connection 215 of the universal interface circuit 320 of the universal station 101. For example, the mechanical connection on the handheld character capture device 501 may be a female connection and the mechanical connection on the universal station 101 may be a male connection. The mechanical connection may include a conventional pin connection that may be fixed on the device 501 housing 505, e.g., on the barrel, so that its connection point is exposed when it is ready for connection with the mechanical connector of the universal station 101.

The mechanical connector can be configured to retract into the device 501 housing 505, be covered with a cover, or left exposed. The mechanical connector may also be configured to include a retractable tether that allows the mechanical connector end to be extended away from the device 501. In alternative embodiments the universal interface connector 540 for the handheld character capture device 501 may be located anywhere along the housing 505 in addition to the an end of the device 501 that is opposite to the outline tip 510. In another embodiment, the universal peripheral connector 540 may be duplicative, for example, one set along the housing 505 of the device 501 and another set at the outline tip 510. This may allow for coupling the handheld character capture device 501 in a small form factor universal station 101. In yet another embodiment, the universal connector interface 540 may be located within or through a cap that is configured to cover the outline tip 510.

The universal station 101 offers a number of advantages, for example, being combined with a cordless transmitter and/or receiver for centralized integration of two or more peripheral devices, e.g., the handheld character capture device 501, a cordless device (e.g., a cordless mouse and/or a cordless keyboard) and a personal digital assistant. This reduces the number of cables and/or connectors required for coupling to a computer.

In addition, the universal station 101 provides an advantage of serving as a recharging station for the peripheral data communication device, e.g., handheld character capture device 501. The universal station 101 also beneficially serves as a storage place for the peripheral data communication device, e.g., handheld character capture device 501. The recharging benefits are attained through use of the electrical interface of the universal station 101. The recharging benefits also allows for keeping a smaller size power source and/or reduces the frequency of replacement in the peripheral data communication device, e.g., the data capture pen device, which may reduce the overall size and weight of that device, while increasing use flexibility.

Upon reading this disclosure, those of skill in the art will appreciate still additional alternative structural and functional designs for universal station. Thus, while particular embodiments and applications of the present invention have been illustrated and described, it is to be understood that the invention is not limited to the precise construction and components disclosed herein and that various modifications, changes and variations which will be apparent to those skilled in the art may be made in the arrangement, operation and details of the method and apparatus of the present invention disclosed herein without departing from the spirit and scope of the invention as defined in the appended claims.

1. a peripheral device station for coupling a plurality of peripheral devices and a host computer system, the station comprising:
a plurality of peripheral device interfaces, each peripheral device interface configured to couple with at least one peripheral device and at least one peripheral device interface comprising a communication connection and a power connection;
a power unit coupled to the power connection and configured to provide an electrical charge for charging a power source of a peripheral device;
a communication intermediary coupled to the communication connection and configured to provide a communication coupling between a peripheral device and the host computer system; and
a host interface configured to couple with and communicate with the host computer system.

2. The peripheral device station of claim 1, wherein the communication intermediary comprises a non-tethered peer-to-peer communication protocol.

3. The peripheral device station of claim 2, wherein the non-tethered peer-to-peer communication protocol comprises a Bluetooth protocol.

4. The peripheral device station of claim 1, wherein the communication intermediary comprises a low-frequency communication protocol.

5. The peripheral device station of claim 4, wherein the low-frequency communication protocol operates in a frequency range of substantially 27 MHz.

6. The peripheral device station of claim 1, wherein the communication intermediary is further configured to provide a virtual wire connection between a peripheral device and the peripheral device station.

7. The peripheral device station of claim 1, wherein the host interface comprises one from a group consisting of a Universal Serial Bus interface, an IEEE 1394 interface, a parallel interface, and a non-tethered peer-to-peer interface.

8. The peripheral device station of claim 7, wherein the non-tethered peer-to-peer interface comprises a Bluetooth interface.

9. The peripheral device station of claim 1, wherein a peripheral device interface of the plurality of peripheral device interfaces comprises a personal digital assistant interface.

10. A centralized station for a use with a plurality of peripheral devices, comprising:
a plurality of stowage areas configured to stow the plurality of peripheral devices;
a plurality of peripheral device interfaces, each configured to couple at least one of the plurality of peripheral devices, at least one of the peripheral device interfaces comprising,
a recharge circuit connection configured to provide an electrical charge for charging a power source in a peripheral device of the plurality of peripheral devices; and
a communication circuit connection configured to provide a communication link with a communication circuit in the peripheral device of the plurality of peripheral devices.

11. The centralized station of claim 10, further comprising a connect circuit configured to create a virtual wire with a peripheral device of the plurality of peripheral devices.

12. The centralized station of claim 11, wherein the connect circuit couples with a keypad for selecting the peripheral device and the peripheral device interface for the virtual wire.

13. The centralized station of claim 10, wherein the communication circuit is configured to provide a tethered connection.

14. The centralized station of claim 13, wherein the tethered connection comprises at least one from a group consisting of a Universal Serial Bus connection, an IEEE 1394 connection, a parallel port connection, and an RS-232 connection.

15. The centralized station of claim 10, wherein the communication circuit is configured to provide a non-tethered connection.

16. The centralized station of claim 15, wherein the non-tethered connection includes at least one from a group consisting of a low-frequency range, a wireless peer-to-peer connection, and a wireless local area network connection.
